(19) United States
(12) Patent Application Publication
(10) Pub. No.: US 2014/0126194 A1
(43) Pub. Date: May 8, 2014

(54) STRAIGHT TUBE LUMINAIRE

(71) Applicant: Sadaaki Matsuura, Tokyo (JP)

(72) Inventor: Sadaaki Matsuura, Tokyo (JP)

(73) Assignee: Shimyau Limited, Tokyo (JP)

(21) Appl. No.: 14/124,112

(22) PCT Filed: Jun. 7, 2012
(86) PCT No.: PCT/JP2012/064676

§ 371 Date: Dec. 5, 2013

(30) Foreign Application Priority Data
Jun. 9, 2011 (JP) 2011-129483

(51) Int. Cl. F21V 19/00; F21V 17/06; F21V 7/00

(52) U.S. Cl. CPC F21V 19/008; F21V 7/005; F21V 17/06
USPC 362/217.05; 362/217.16

(57) ABSTRACT

A straight tube luminaire, detachably attached between one pair of opposed rotary sockets, includes one pair of connection terminals electrically connected to each of the pair of rotary sockets within a predetermined rotational range of the rotary sockets, one pair of straight tube illumination sockets electrically connected to the connection terminals and electrically connected to electrodes provided at both ends of a rectilinear fluorescent lamp, and a reflective plate extended between the pair of straight tube illumination sockets and attached to the straight tube illumination sockets to reflect light of the fluorescent lamp. The reflective plate and the straight tube illumination sockets are rotated as one body together with the connection terminals by inserting the connection terminals into the rotary sockets and rotating the rotary sockets.

### TECHNICAL FIELD

The present invention relates to a straight tube luminaire that is attached to a socket for attaching a straight tube illuminating lamp and that is capable of lighting a straight tube illuminating lamp having a different size.

### BACKGROUND ART

In recent years, importance of energy saving has increased from the viewpoint of global warming. In straight tube type illumination, energy saving is also demanded. For example, therefore, demand for LEDs which are less in power dissipation than fluorescent lamps is increasing.

LEDs give a peculiar stimulus. According to differences between individuals, eye fatigue tends to occur and the LEDs do not offer a comfort in some cases. Accordingly, a technique of implementing mildness to eyes and energy saving by attaching a T5 straight tube fluorescent lamp (tube diameter: 15.5 mm), which is less in power dissipation than a T8 straight tube fluorescent lamp (tube diameter: 25.5 mm) used generally heretofore, to lamp sockets for the T8 straight tube type fluorescent lamp via auxiliary devices is known (see, for example, Patent Literature 1).

### CITATION LIST

### Patent Literature

Patent literature 1: Japanese Unexamined Patent Application Publication (Translation of PCT Application) No. 2004-529459

### SUMMARY OF INVENTION

### Technical Problem

In the case of, for example, LED illumination, however, the irradiation range of light is narrow and limited as compared with fluorescent lamps and the like, and consequently there is a fear that unevenness of light will occur with respect to an irradiation object, resulting in lowered comfort. Furthermore, in the case of the T5 straight tube fluorescent lamp, power dissipation is less as compared with the T8 straight tube fluorescent lamp and consequently the quantity of light decreases and the comfort tends to be hampered in the same way.

The present invention has been made to solve the problems caused by the conventional techniques. An object of the present invention is to provide a straight tube luminaire capable of preventing comfort from falling while attempting energy saving in straight tube illumination.

### Solution to Problem

A straight tube luminaire according to the present invention achieving the object is a straight tube luminaire attached between one pair of opposed rotary sockets to be removable, the straight tube luminaire including one pair of connection terminals electrically connected to each of the pair of rotary sockets within a predetermined rotation range of the rotary sockets, one pair of straight tube illumination sockets electrically connected to the connection terminals and electrically connected to electrodes provided at both ends of a rectilinear straight tube illuminating lamp, and a reflective plate extended between the pair of straight tube illumination sockets and attached to the straight tube illumination sockets to reflect light of the straight tube illuminating lamp, the reflective plate and the straight tube illumination sockets being rotated as one body together with the connection terminals by inserting the connection terminals into the rotary sockets and rotating the rotary sockets.

### Advantageous Effects of the Invention

In the straight tube luminaire according to the present invention having the above-described configuration, the reflective plate and the straight tube illumination sockets rotate together with the connection terminals as one body by inserting the connection terminals into the rotary sockets and rotating the rotary sockets. Therefore, the irradiation direction of light via the reflective plate can be set by disposing the connection terminals in arbitrary rotational positions electrically connectable to the rotary sockets. It is possible to prevent the comfort from falling while attempting energy saving in straight tube illumination. Furthermore, lighting and light out of the straight tube illuminating lamp can be switched by rotating the straight tube luminaire about the rotary sockets. For example, in a case where a plurality of straight tube luminaires exist on a ceiling, it can be easily set to prevent some straight tube luminaires from lighting by only rotating some straight tube luminaires. It is possible to decrease straight tube luminaires that are lit and attempt energy saving by simple work.

If the straight tube luminaire is a straight tube luminaire including holding parts which rotate together with the connection terminals as one body by inserting the connection terminals into the rotary sockets and rotating the rotary sockets, and which includes circular arc shaped peripheral faces having a center axis of the rotation as a center, and auxiliary members fixed to sides on which the rotary sockets are disposed and capable of covering peripheral faces of the holding parts and holding the peripheral faces in arbitrary rotational positions to fix the rotation, it is possible to hold the rotational position of the straight tube luminaire easily, adjust the irradiation direction of the straight tube illumination, and prevent the straight tube luminaire from falling. Especially, when it is set to prevent lighting by rotating the straight tube luminaires located on the ceiling, the connection terminals are brought into a state where they are apt to slip out of the rotary sockets and the straight tube luminaires become apt to fall. Even in such a state, however, the straight tube luminaires can be prevented from falling because the auxiliary members hold the peripheral faces of the holding parts.

Furthermore, if the straight tube luminaire is a straight tube luminaire supplying a current to a straight tube illuminating lamp, the straight tube luminaire including socket housings which can be attached to and detached from a base and which can be electrically connected to a power supply, rotary sockets for straight tube illumination electrically connected to electrodes provided on end parts of a rectilinear straight tube illuminating lamp, and auxiliary members capable of covering peripheral faces of the straight tube illuminating lamp and holding the peripheral faces in arbitrary rotational positions to fix the rotation, lighting and light out can be switched easily by attaching the socket housing to the base, attaching a straight tube illuminating lamp to the straight tube illumination sockets while holding the straight tube illuminating lamp with the auxiliary members, and rotating the straight tube illuminating lamp. As a result, energy saving can be attempted.

If the straight tube luminaire further includes a distribution part which is electrically connected to the power supply and which supplies current to the sockets for straight tube illumination, it is possible to supply current to the sockets for straight tube illumination easily by only connecting the power supply to the distribution part.

### BRIEF DESCRIPTION OF DRAWINGS

FIG. 1 is a plane view illustrating a straight tube luminaire according to a first embodiment of the present invention.

FIG. 2 is a plane view illustrating an end part of the straight tube luminaire.

FIG. 3 is an arrow view along an A-A line in FIG. 2.

FIG. 4 is a sectional view illustrating rotary sockets to which the straight tube luminaire is attached.

FIG. 5 is a plane view illustrating a case when the straight tube luminaire is attached to rotary sockets.

FIG. 6 is a plane view illustrating a case when the straight tube luminaire is attached to rotary sockets.

FIG. 7 is a plane view illustrating the straight tube luminaire attached to the rotary sockets.

FIG. 8 is a plane view illustrating a straight tube luminaire according to a second embodiment of the present invention.

FIG. 9 is an arrow view along a B-B line in FIG. 8.

FIG. 10 is a plane view illustrating a case when the straight tube luminaire is attached to a base.

FIG. 11 is a plane view illustrating a case when a straight tube illuminating lamp is attached to the straight tube luminaire.

FIG. 12 is a plane view illustrating a case when the straight tube illuminating lamp is attached to the straight tube luminaire.

FIG. 13 is a plane view illustrating an auxiliary member in a case when the straight tube luminaire is attached.

### DESCRIPTION OF EMBODIMENTS

Hereafter, embodiments of the present invention will be described with reference to the drawings. Meanwhile, in description of the drawings, the same elements are denoted by like reference characters and duplicated description will be omitted.

### First Embodiment

A straight tube luminaire 10 according to a first embodiment makes it possible to attach a T5 straight tube fluorescent lamp 100 (straight tube illuminating lamp), which is smaller in diameter and less in power dissipation than a T8 straight tube fluorescent lamp, by attaching it to rotary sockets 20 for attaching a T8 straight tube fluorescent lamp thereto.

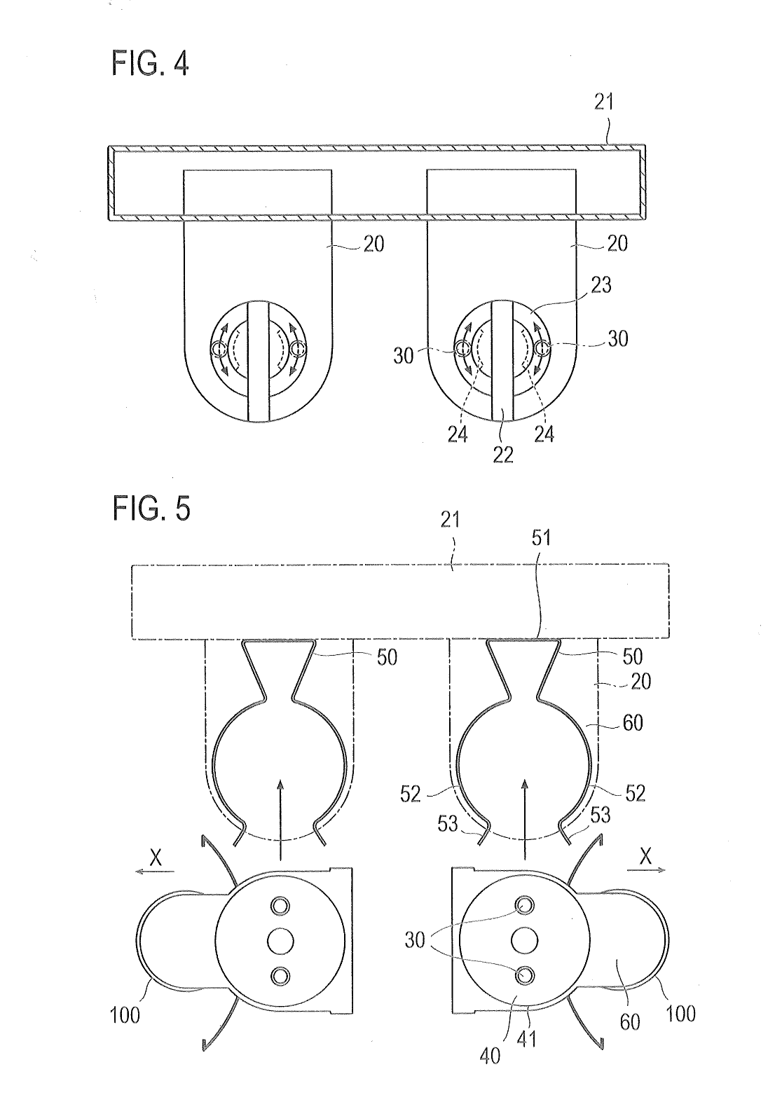

As illustrated in FIG. 4, the rotary sockets 20 are fixed to a base 21 attached to a ceiling. As a two-lamp system in which two fluorescent lamps are lighted, two pairs of rotary sockets are provided on one base. Each rotary socket 20 includes a slit 22 into which two electrodes projecting from each of both ends of a fluorescent lamp are inserted, a circular groove 23 which makes the electrodes inserted into the slit 22 rotatable, and power supply terminals 24 which come in contact with the electrodes moved to predetermined rotational positions in the circular groove 23 and make it possible to apply a current to the electrodes. Meanwhile, since the rotary sockets 20 are generally used sockets, description of other detailed configurations will be omitted.

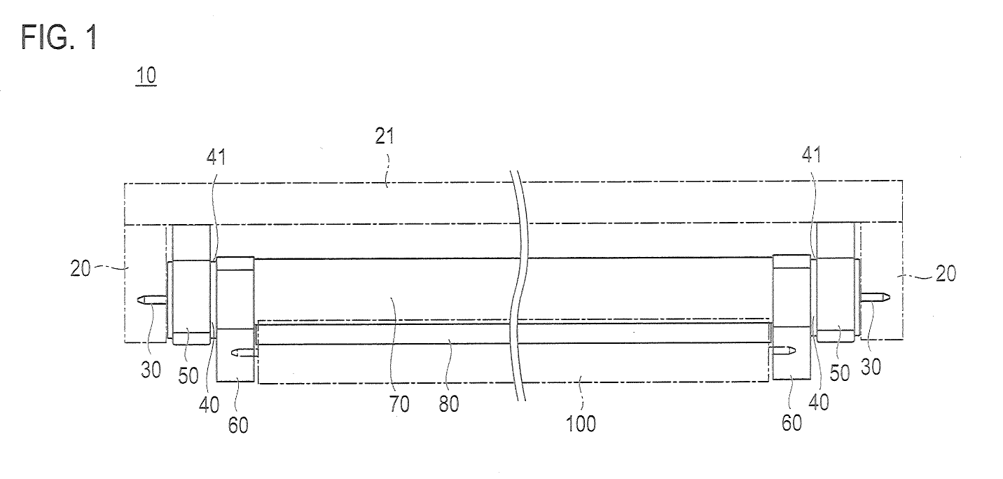

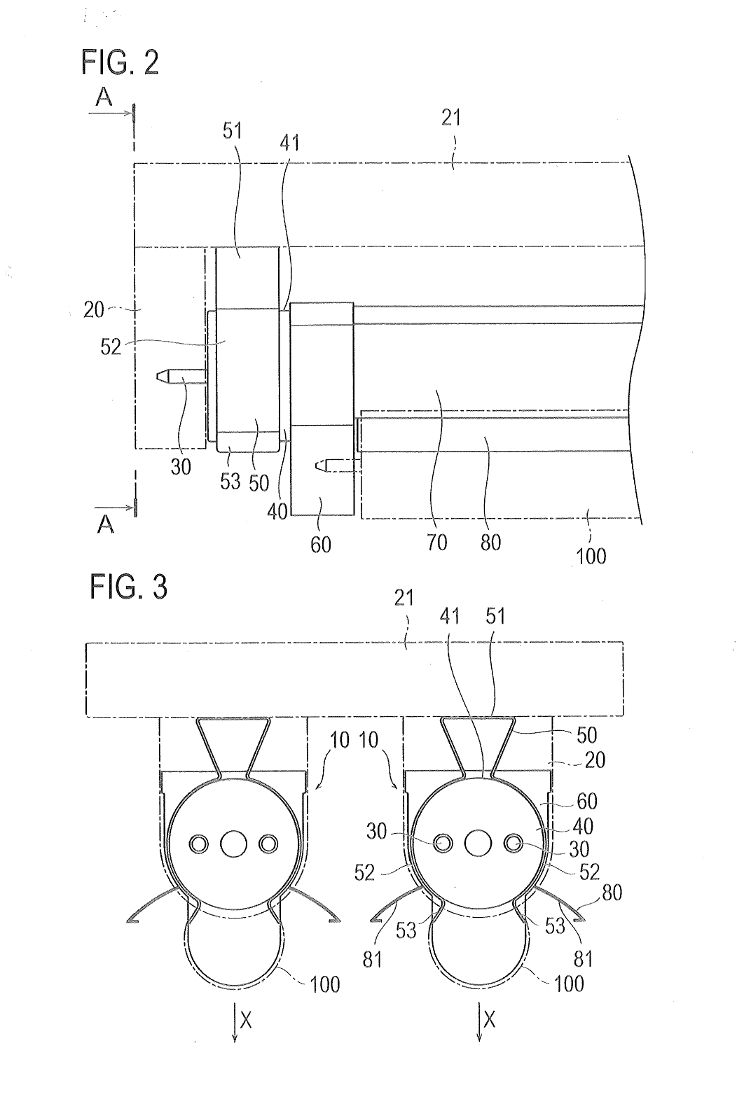

Two straight tube luminaires 10 are provided to light two fluorescent lamps 100 with respect to one base 21. As illustrated in FIGS. 1 to 3, each straight tube luminaire 10 includes connection terminals 30 electrically connected to power supply terminals 24 respectively of one pair of rotary sockets 20, holding parts 40 to which the connection terminals 30 are linked, auxiliary members 50 in contact with peripheral faces 41 of the holding parts 40, straight tube illumination sockets 60 to which the T5 straight tube fluorescent lamp 100 is connected, a main body part 70 linked between two opposite straight tube illumination sockets 60, and a reflective plate 80. Furthermore, each straight tube luminaire 10 has a substrate (not illustrated) including an inverter, and has a structure in which the straight tube luminaire 10 is lighted in an inverter system. Meanwhile, the structure of the inverter is generally used, and description thereof will be omitted.

The connection terminal 30 has the same shape as the electrode terminal of the T8 straight tube fluorescent lamp. Two connection terminals 30 are formed to be projected from each of both ends. The two connection terminals 30 at each end part can be inserted into the slit 22 of the rotary socket 20. The two connection terminals 30 intrude into the circular groove 23 by rotating the terminals 30 in a state where the terminals are inserted into the slit 22. The two connection terminals 30 come in contact with the power supply terminals 24 disposed in predetermined rotational positions in the circular groove 23. A range in which the connection terminals 30 come in contact with the power supply terminals 24 has a determinate width in the rotation direction in the circular groove 23. For example, they come in contact with each other in a range of 75 to 105 degrees from a state where the connection terminals 30 are inserted into the slit 22. Two connection terminals 30 at each end part are disposed to form a line in the horizontal direction in a state where the straight tube luminaire 10 is attached to the rotary socket 20 to apply light downward.

The holding part 40 is formed to take a columnar shape having the peripheral face 41 that takes a shape of a circular arc around a rotation axis at the time when the connection terminal 30 is attached to the rotary socket 20. The holding part 40 is linked to the connection terminal 30.

The auxiliary member 50 is formed by bending an elastically deformable plate member. The auxiliary member 50 includes a base end part 51 fixed to the base 21 on which the rotary sockets 20 are disposed, by a bonding adhesive, double-sided tape, a bolt, or the like, two circular arc parts 52 formed to extend from the base end part 51 and cover the peripheral face 41 of the holding part 40, and opening parts 53 respectively provided at front ends of the circular arc parts 52 to open in mutually separating directions. The opening part 53 causes the two opposed circular arc parts 52 to separate from each other by contact with the holding part 40 and facilitates intrusion of the holding part 40 into a space between the two circular arc parts 52. The two circular arc parts 52 sandwich and hold the holding part 40 which has intruded into the space between them with elastic force, and prevent the holding part 40 from leaving the space between the circular arc parts 52. And the two circular arc parts 52 can hold the peripheral face 41 of the holding part 40 in an arbitrary rotational position while fixing the rotation.

The straight tube illumination sockets 60 are linked to respective holding parts 40 and are disposed to be opposed to each other. The straight tube illumination sockets 60 are formed to correspond to sizes of the T5 straight tube fluorescent lamp 100 which is the object of attachment. The straight tube illumination sockets 60 are general push-on sockets having bayonet bases which are biased by springs or the like and which can retreat. However, the straight tube illumination sockets 60 may be sockets having any configuration as long as the T5 straight tube fluorescent lamp 100 can be attached thereto. For example, the straight tube illumination sockets 60 may be rotary sockets.

The main body part 70 is formed to conduct linking between the two opposed straight tube illumination sockets 60 and extend along the attached T5 straight tube fluorescent lamp 100.

The reflective plate 80 is disposed to be fixed to the main body part 70. Concave shaped reflective faces 81 each forming a circular arc are formed to front on the T5 straight tube fluorescent lamp 100 and extend. Owing to the reflective face 81, light-gathering capability can be enhanced. The reflective face 81 is formed of aluminum to reflect light. However, the material of the reflective face 81 is not restricted to aluminum as long as the function of reflecting light can be exhibited. Therefore, a direction in which the reflective faces 81 front on the T5 straight tube fluorescent lamp 100 becomes an irradiation direction X with light (see FIG. 3).

Action of the straight tube luminaire 10 according to the present embodiment will now be described.

First, as illustrated in FIG. 5, the base end part 51 of the auxiliary member 50 is fixed in the vicinity of each of the rotary sockets 20 of the base 21, i.e., in a position on the base 21 corresponding to the holding part 40 of the attached straight tube luminaire 10 by a bonding adhesive, double-sided tape, a bolt, or the like. And the T5 straight tube fluorescent lamps 100 are attached to the straight tube illumination sockets 60 in the straight tube luminaire 10.

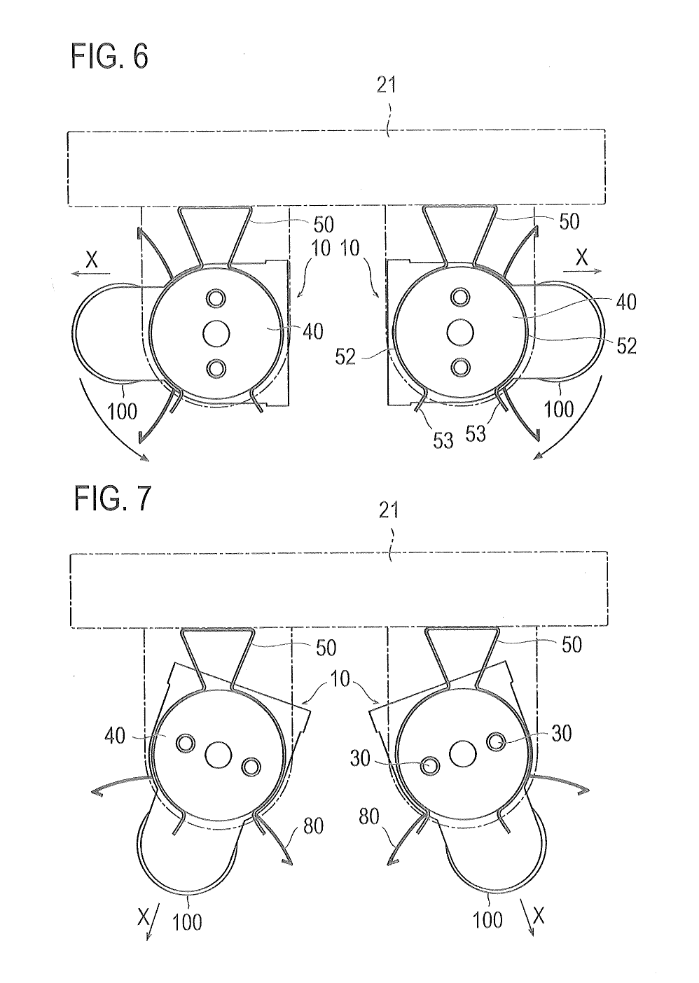

Then, disposition is conducted to cause the irradiation direction X of the straight tube luminaire 10 to become the horizontal direction. In a state where two connection terminals 30 provided at each end part form a line in the vertical direction, the two connection terminals 30 are inserted into the slit 22 (see FIG. 4) in the rotary socket 20 as shown in FIG. 5 and FIG. 6. At this time, the holding part 40 intrudes into the space between the two circular arc parts 52 while opening the opening part 53 in the auxiliary member 50. The auxiliary member 50 sandwiches and holds the holding part 40, which has intruded into the space between the two circular arc parts 52, with elastic force, and prevents the straight tube luminaire 10 from falling.

Then, as illustrated in FIG. 3, the straight tube luminaires 10 are rotated to cause the irradiation direction X to become downward. As a result, the connection terminals 30 rotate in the circular grooves 23 of the rotary sockets 20 and come in contact with the power supply terminals 24 disposed in predetermined rotational positions in the circular grooves 23 (see FIG. 4). As a result, it becomes possible to apply currents from the power supply terminals 24 to the T5 straight tube fluorescent lamps 100 attached to the straight tube luminaires 10 via the connection terminals 30, the inverters, and the straight tube illumination sockets 60.

Furthermore, if the connection terminals 30 are inserted into the rotary sockets 20 and rotated, all parts of the straight tube luminaires 10 except the auxiliary members 50 fixed to the base 21 rotate together with the connection terminals 30 as one body. And since a range in which the power supply terminals 24 disposed in predetermined rotational positions in the circular groove 23 come in contact with the connection terminals 30 has a determinate width in the rotation direction of the circular groove 23, the irradiation direction X can be made a direction deviated from the vertical direction as illustrated in FIG. 7. In this way, the T5 straight tube fluorescent lamps 100 which are low in power dissipation are made usable to attempt energy saving. At the same time, the connection terminals 30 are disposed in arbitrary rotational positions electrically connectable to the rotary sockets 20. As a result, the irradiation direction X with light can be set in an arbitrary direction by utilizing the reflective plate 80 having high light-gathering capability, and deterioration of comfort can be suppressed.

Furthermore, since the circular arc part 52 of the auxiliary member 50 can hold the peripheral face 41 of the holding part 40 in an arbitrary rotational position to fix the rotation, the irradiation direction X of the fluorescent lamp 100 can be adjusted easily and the safety can be improved by preventing the straight tube luminaire 10 from falling.

Furthermore, lighting and light out of the fluorescent lamp 100 (straight tube illuminating lamp) can be switched by rotating the straight tube luminaire 10 about the rotary sockets 20. For example, in a case where a plurality of straight tube luminaires 10 exist on a ceiling, it can be easily set to prevent some fluorescent lamps 100 from lighting by only rotating some straight tube luminaires 10. It is possible to decrease fluorescent lamps 100 that are lit and attempt energy saving by simple work. Especially, when it is set to prevent lighting by rotating the straight tube luminaires located on the ceiling as shown in FIG. 6, the connection terminals 30 are brought into a state where they are apt to slip out of the rotary sockets 20 and the straight tube luminaires 10 become apt to fall. Even in such a state, however, the straight tube luminaires 10 can be prevented from falling because the auxiliary members 50 hold the peripheral faces 41 of the holding parts 40.

Furthermore, if only one fluorescent lamp is attached to the rotary sockets 20 in a case of a two-lamp system typically having two pairs of rotary sockets 20, lighting of the fluorescent lamp may be instable in some structures. However, each straight tube luminaire 10 has the substrate including the inverter. Even if two straight tube luminaires 10 are attached to two pairs of rotary sockets 20 and one of the straight tube luminaires 10 is rotated and turned off as illustrated in FIG. 6, therefore, only the other fluorescent lamp 100 can be lit.

Meanwhile, the present invention is not limited to the above described embodiment. Various changes can be made in the scope of the claims. For example, the straight tube luminaire 10 according to the present embodiment is the inverter type. However, the straight tube luminaire 10 may be the rapid-start type or glow type. Furthermore, the straight tube luminaire 10 according to the present embodiment lights the T5 straight tube fluorescent lamp 100 by utilizing the rotary sockets 20 for the T8 straight tube fluorescent lamp. However, the utilized rotary sockets are not limited to the rotary sockets for the T8 straight tube fluorescent lamp, and the attached fluorescent lamp is not limited to the T5 straight tube fluorescent lamp.

Furthermore, in the straight tube luminaire 10 according to the present embodiment, the T5 straight tube fluorescent lamp which is smaller in diameter and length than the T8 straight tube fluorescent lamp is attached to the rotary sockets 20 for the T8 straight tube fluorescent lamp. However, the attached straight tube illuminating lamp may be equal to or larger than the straight tube illuminating lamp which is the attachment object to the rotary sockets in diameter and length.

Furthermore, the attached straight tube illuminating lamp may be a straight tube illuminating lamp that is different in shape of electrodes or the like because of a change of standards and the like . In this case, it is desirable to change the form of the straight tube illumination sockets 60 according to the shape of the attached straight tube illuminating lamp.

In addition, in the straight tube luminaire 10 according to the present embodiment, the straight tube fluorescent lamp 100 is attached to the straight tube illumination sockets 60. However, the attached illuminating lamp is not limited to the fluorescent lamp. For example, a straight tube LED illuminating lamp may be attached to the straight tube illumination sockets 60. Usually, in the LED illuminating lamp, the irradiation range of light is narrow and limited as compared with fluorescent lamps and the like, and consequently unevenness of light tends to occur with respect to an irradiation object. However, the irradiation direction of light becomes adjustable and the comfort can be improved by using the straight tube luminaire 10 according to the present embodiment.

Furthermore, the straight tube luminaire 10 according to the present embodiment is attached to the rotary sockets 20 for fluorescent lamp. However, the rotary sockets are not limited to those for fluorescent lamp, either. The straight tube luminaire 10 may be attached to, for example, rotary sockets for LED illuminating lamp.

Furthermore, as for the rotary socket, its structure is not limited as long as it can hold the rotating connection terminals 30 while making it possible to let a current flow through the rotating connection terminals 30. The rotary socket may have a special shape different from that according to generally distributed standards.

### Second Embodiment

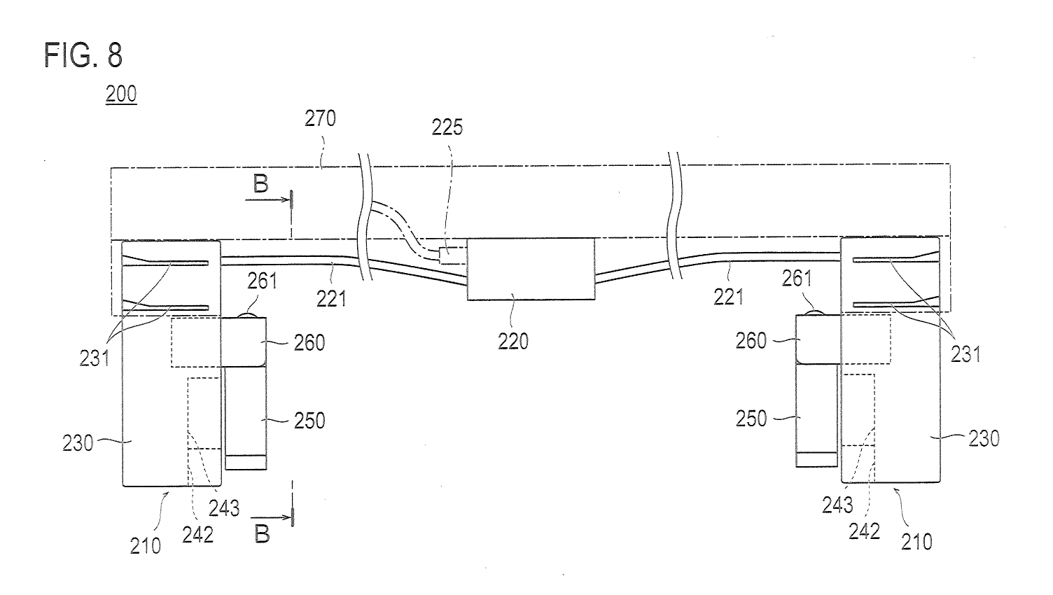

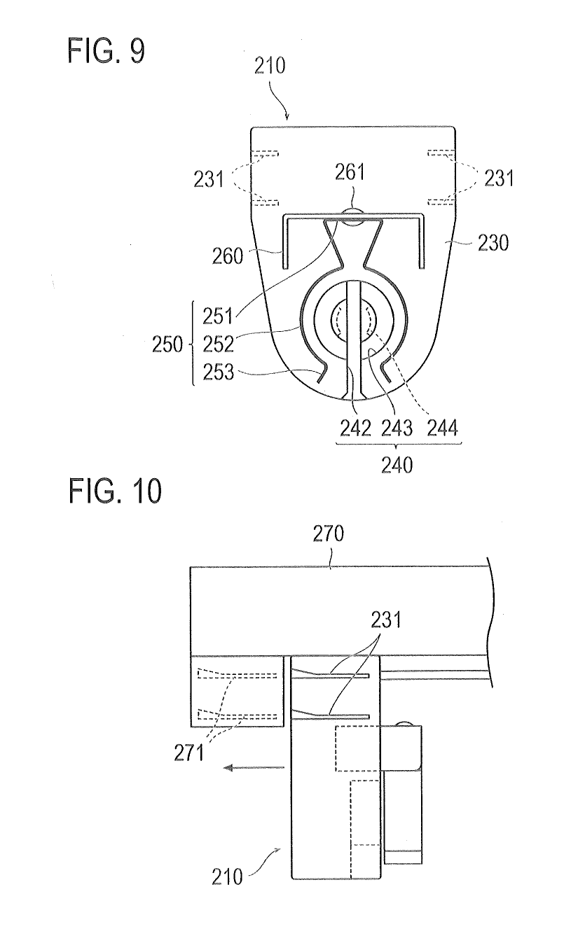

A straight tube luminaire 200 according to a second embodiment, as shown in FIG. 8 and FIG. 9, is a device that is removably attached to a base 270 on which sockets for attaching a straight tube illuminating lamp is removed, and that makes it possible to attach a straight tube illuminating lamp of different standards. Meanwhile, hereafter, an example in which, for example, push-in type sockets are removed from the base 270 for T8 straight tube fluorescent lamp and it is made possible to light the T5 straight tube fluorescent lamp 100 will be described.

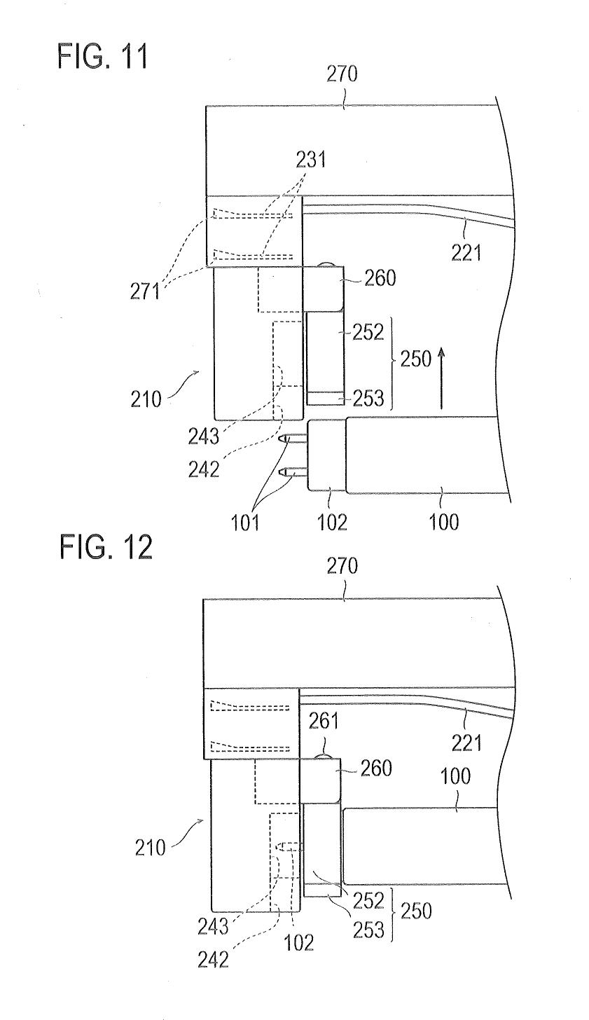

The straight tube luminaire 200 includes two socket parts 210 to be connected to electrodes 101 (see FIG. 11) at both ends of the fluorescent lamp 100, and a distribution part 220 which supplies current to two socket parts 210 via cables 221 by connecting AC power supply 225.

The socket part 210 includes a socket housing 230. The socket housing 230 has mounting grooves 231, into which a linking convex part 271 (see FIG. 10) provided on the base 270 can fit, on both side faces. A rotary socket 240 for straight tube illuminating lamp is provided in the socket housing 230. The rotary socket 240 for straight tube illuminating lamp includes a slit 242 into which two electrodes 101 projected from an end part of the fluorescent lamp 100 are inserted, a circular groove 243 which makes it possible to rotate the electrodes 101 inserted into the slit 242, and power supply terminals 244 which come in contact with the electrodes 101 moved to predetermined rotational positions in the circular groove 243 and make it possible to apply currents to the electrodes 101.

The two electrodes 101 of an end part of the fluorescent lamp 100 intrude into the circular groove 243 by rotating the electrodes 101 in a state where the electrodes are inserted into the slit 242. The two electrodes 101 come in contact with the power supply terminals 244 disposed in predetermined rotational positions in the circular groove 243. A range in which the supply terminals 244 come in contact with the electrodes 101 has a determinate width in the rotation direction of the circular groove 243. For example, they come in contact with each other in a range of 75 to 105 degrees from a state where the electrodes 101 are inserted into the slit 242. Two electrodes 101 at each end part are disposed to roughly horizontally form a line in a state where irradiation of light is conducted.

In addition, an auxiliary member 250 in contact with a peripheral face 102 of an end part of the fluorescent lamp 100 is linked to the socket housing 230 via a bracket 260. The bracket 260 has a detachable structure which is linked to the socket housing 230 by inserting it into the socket housing 230. However, the bracket 260 may be fixed to the socket housing 230 without being detachable.

The auxiliary member 250 is formed by bending an elastically deformable plate member. The auxiliary member 250 includes a base end part 251 fixed to the bracket 260 by a rivet 261, two circular arc parts 252 formed to extend from the base end part 251 and cover the peripheral face 102 (see FIG. 11) of the fluorescent lamp 100, and opening parts 253 respectively provided at front ends of the circular arc parts 252 to open in mutually separating directions. The opening part 253 causes the two opposed circular arc parts 252 to separate from each other by contact with the fluorescent lamp 100 and facilitates intrusion of the fluorescent lamp 100 into a space between the two circular arc parts 252. The two circular arc parts 252 sandwich and hold the fluorescent lamp 100 which has intruded into the space between them with elastic force, and prevent the fluorescent lamp 100 from leaving the space between the circular arc parts 252. And the two circular arc parts 252 can hold the peripheral face 102 of the fluorescent lamp 100 in an arbitrary rotational position while fixing the rotation.

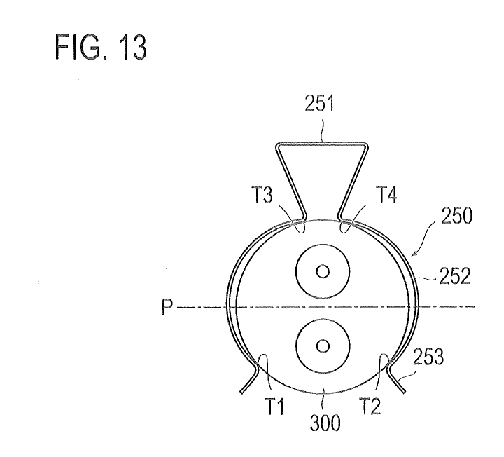

Since the auxiliary member 250 is elastically deformable, it can also sandwich and hold an illuminating lamp having a different diameter. In the present embodiment, designing is conducted so that the whole circular arc part 252 comes in contact with the T5 straight tube illuminating lamp when the T5 straight tube fluorescent lamp 100 is located. As illustrated in FIG. 13, however, it is also possible to attach an illuminating lamp 300 such as, for example, a T8 straight tube or an LED illuminating lamp etc., that is larger in outside diameter than the T5 straight tube. In other words, when attaching an illuminating lamp 300 having a large outside diameter, the circular arc part 252 spreads out, and two points T1 and T2 on the circular arc part 252 located near the opening part 253 and two points T3 and T4 on the circular arc part 252 located near the base end part 251 sandwich and hold the illuminating lamp. At this time, it is desirable that the two points T1 and T2 on the circular arc part 252 located near the opening part 253 are located below a plane P passing through a center line of the illuminating lamp 300 in a direction of gravitational force to positively hold the illuminating lamp 300.

Action of the straight tube luminaire 200 according to the second embodiment will now be described.

First, as illustrated in FIGS. 10 and 11, the distribution part 220 is fixed to the base 270 or a ceiling part, and then the AC power supply 225 is connected to the distribution part 220. Thereafter, the socket part 210 is slid about the base 270 to cause the linking convex part 271 provided on the base 270 with conventional sockets removed to fit into the mounting grooves 231. As a result, two socket parts 210 to be connected to ends of the fluorescent lamp 100 are linked to the base 270.

Then, in a state where the two electrodes 101 provided at each end of the fluorescent lamp 100 form a line in the vertical direction, the electrodes 101 are inserted into the slit 242 in the socket part 210 as illustrated in FIGS. 11 and 12. At this time, the peripheral face 102 of the fluorescent lamp 100 intrudes into the space between the two circular arc parts 252 while opening the opening part 253 in the auxiliary member 250. The auxiliary member 250 sandwiches and holds the peripheral face 102, which has intruded into the space between the two circular arc parts 252, with elastic force, and prevents the fluorescent lamp 100 from falling.

Then, the fluorescent lamp 100 is rotated. As a result, the electrodes 101 rotate in the circular groove 243 and come in contact with the power supply terminals 244 disposed in predetermined rotational positions in the circular groove 243. Accordingly, it becomes possible to apply a current to the fluorescent lamp 100 attached to the straight tube luminaire 200.

According to the straight tube luminaire 200 in the second embodiment, it becomes possible to use the T5 straight tube fluorescent lamp 100 which is less in power dissipation and attempt energy saving by attaching the straight tube luminaire 200 instead of the conventional sockets.

Furthermore, a current can be supplied from the distribution part 220 connected to the AC power supply 225 to the socket parts 210. Therefore, the current can be supplied to the socket parts 210 by only connecting the AC power supply 225 to the distribution part 220. The luminaire can be installed easily without requiring a large-scale construction.

Furthermore, since the auxiliary member 250 is provided, the fluorescent lamp 100 can be held in a range in which the electrodes 101 of the fluorescent lamp 100 are not in contact with the power supply terminals 244. In a state where the fluorescent lamp 100 is attached to the straight tube luminaire 200, it is possible to set so that the fluorescent lamp does not light. At this time, since the peripheral face 102 of the fluorescent lamp 100 is sandwiched by the auxiliary member 250, the fluorescent lamp 100 can be prevented from falling. For example, therefore, in a case where a plurality of straight tube luminaires 200 exist on a ceiling, it can be easily set so that fluorescent lamps 100 does not light by only rotating some fluorescent lamps 100. It is possible to decrease fluorescent lamps 100 that are lit and attempt energy saving by simple work.

Meanwhile, the straight tube luminaire 200 according to the second embodiment lights the T5 straight tube fluorescent lamp 100 by utilizing the base 270 for the T8 straight tube fluorescent lamp. However, the utilized base 270 is not limited to the base for the T8 straight tube fluorescent lamp, and the attached fluorescent lamp is not limited to the T5 straight tube fluorescent lamp. Especially in the present embodiment, the elastically deformable auxiliary member 250 is provided. Therefore, straight tube illuminating lamps of different standards can be coped with by one type of the straight tube luminaire 200.

Furthermore, the attached straight tube illuminating lamp may be a straight tube illuminating lamp that is different in shape of electrodes and the like because of a change of standards or the like. In this case, it is desirable to change the form of the straight tube illumination sockets 240 according to the shape of the attached straight tube illuminating lamp.

In addition, the attached illuminating lamp is not limited to the fluorescent lamp. For example, straight tube LED illuminating lamp may be attached.

Furthermore, the straight tube luminaire 200 according to the second embodiment has been described as a one lamp system. However, the straight tube luminaire 200 may be a two-lamp system.

The present application is based on Japanese Patent Application No. 2011-129483 filed on Jun. 9, 2011 and disclosure thereof is referenced and incorporated as a whole.

### REFERENCE SIGNS LIST

10, 100 Straight tube luminaire
20 Rotary socket
30 Connection terminal
40 Holding part
41 Peripheral face
50, 250 Auxiliary member
60, 240 Straight tube illumination socket
70 Main body part
80 Reflective plate
100 Fluorescent lamp (straight tube illuminating lamp)
101 Electrode
102 Peripheral face
210 Socket part
220 Distribution part
225 AC power supply
230 Socket housing
270 Base
X Irradiation direction

1. A straight tube luminaire detachably attached between one pair of opposed rotary sockets, the straight tube luminaire comprising:
a pair of connection terminals electrically connected to each of the pair of rotary sockets within a predetermined rotational range of the rotary sockets;
a pair of straight tube illumination sockets electrically connected to the connection terminals and electrically connected to electrodes provided at both ends of a rectilinear straight tube illuminating lamp; and
a reflective plate extended between the pair of straight tube illumination sockets and attached to the straight tube illumination sockets to reflect light of the straight tube illuminating lamp,
wherein the reflective plate and the straight tube illumination sockets rotate as one body together with the connection terminals by inserting the connection terminals into the rotary sockets and rotating the rotary sockets.

2. The straight tube luminaire according to claim 1, comprising:
holding parts which rotate together with the connection terminals as one body by inserting the connection terminals into the rotary sockets and rotating the rotary sockets, and which comprise circular arc shaped peripheral faces having a central axis of the rotation as a center; and
auxiliary members fixed to sides on which the rotary sockets are disposed and capable of covering peripheral faces of the holding parts and holding the peripheral faces in arbitrary rotational positions to fix the rotation.

3. A straight tube luminaire supplying a current to a straight tube illuminating lamp, the straight tube luminaire comprising:
socket housings which can be attached to and detached from a base and which can be electrically connected to a power supply;
rotary sockets for straight tube illumination electrically connected to electrodes provided on end parts of a rectilinear straight tube illuminating lamp; and
auxiliary members capable of covering peripheral faces of the straight tube illuminating lamp, holding the peripheral faces in arbitrary rotational positions, and fixing the rotation.

4. The straight tube luminaire according to claim 3, further comprising a distribution part electrically connected to the power supply to supply currents to the sockets for straight tube illumination.
